(19) United States
(12) Patent Application Publication
(10) Pub. No.: US 2012/0112500 A1
(43) Pub. Date: May 10, 2012

(54) Vehicle Seating Apparatus

(76) Inventors: Timothy Graham Rundle, Auckland (NZ); Lauren Mary Grace Van Uden, Auckland (NZ); Andrew Bissett, Matakana (NZ); Gavin Edward Balasingam, Auckland (NZ); Mitchell Hughes, Auckland (NZ); Kerry Alan Reeves, Auckland (NZ); Victoria Anne Bamford, Auckland (NZ); Matthew James Cooper, Manukau City (NZ); Glen Wilson Porter, Christchurch (NZ); Stephen Lee Kim, San Francisco, CA (US); Leslie Rae Witt, Redwood City, CA (US); Stacey Hsu-Wen Chang, Sunnyvale, CA (US); Jeremy John Sutherland, San Francisco, CA (US); Daniel McLaughlin, London (GB)

(21) Appl. No.: 12/744,197

(22) PCT Filed: Nov. 21, 2008
(86) PCT No.: PCT/NZ2008/000312

§ 371 Date: Sep. 14, 2011

Related U.S. Application Data
(60) Provisional application No. 60/996,521, filed on Nov. 21, 2007.
(60) Provisional application No. 61/071,856, filed on May 21, 2008.

(30) Foreign Application Priority Data
May 21, 2008 (NZ) 568502

(51) Int. Cl. B60N 2/01; A47B 83/02; A47C 7/72

(52) U.S. Cl. 297/147; 297/232; 297/217.4; 297/135

(57) ABSTRACT

The invention comprises a vehicle and seating arrangement having a central hub with four sides surrounded by four seats. The seats are arranged adjacent a respective side of the hub and facing substantially parallel to the side of the hub. In at least one embodiment, the arrangement provides access for each passenger to the aisle.

### FIELD OF INVENTION

The present invention relates to passenger vehicle seating arrangements. More particularly but not exclusively it relates to aircraft seating arrangements.

### BACKGROUND OF THE INVENTION

Passenger vehicles such as aircraft, trains, and buses have a limited floor area in which to arrange seating. In passenger vehicles, it is often desirable to maximise the number of seats which will fit into the floor area. More efficient use of the floor area may allow for more passengers to travel on the vehicle.

Passenger comfort is also an important consideration in the design of vehicle seating arrangements. Having adequate leg room is important to some passengers. Common seating arrangements in which all of the seats face forward often do not provide adequate leg room. This is a common problem, especially in passenger aircraft.

The ability to recline the seat is also an important factor in the design of vehicle seating arrangements. Reclining seats provide greater comfort to a passenger. Common seating arrangements in which all of the seats face forward can be problematic in their seat reclining functionality. This is because when a seat is reclined the seat back impedes on the passenger sitting behind. Therefore, the distance a seat is allowed to recline is usually restricted to a distance that will not substantially impede on the passenger behind.

Common vehicle seating arrangements do not offer flexibility by allowing a passenger to have privacy as well as the option of engaging with other passengers should they wish to. Existing vehicle seating arrangements either give the passenger privacy, or the ability to engage with other passengers, but not both.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

It is an object of the present invention to provide to provide a passenger vehicle seating arrangement which overcomes or at least ameliorates some of the abovementioned disadvantages or which at least provides the public with a useful choice.

### BRIEF SUMMARY OF THE INVENTION

Accordingly, in a first aspect the present invention broadly consists in a vehicle seating arrangement comprising or including:

a central hub having four sides,

a seat located adjacent to, and facing in a direction substantially parallel with, each side of the central hub.

Preferably, each seat is located relative said side of the hub to which it is adjacent, so that the front edge of each seat, at least when the seat is in the fully upright position, does not project beyond said side of the hub.
Preferably, each seat is located relative said side of the hub to which it is adjacent, so that the front edge of each seat, at least when the seat is in the fully upright position, is located intermediate of the distal ends of said side.
Preferably, each seat is set relative said side of the hub to which it is adjacent, so that the back each seat, at least when the seat is in the fully upright position, extends beyond one of the distal ends of said side.
Preferably, the central hub is substantially square in plan shape.
Preferably, the right hand side of each seat is adjacent to the central hub so that the seats face in a clockwise direction about the central hub.
Preferably, the left hand side of each seat is adjacent to the central hub so that the seats face in an anti-clockwise direction about the central hub.
Preferably, the seating arrangement enables passengers to assume a first position in which they face in a direction substantially parallel to the direction that the seat faces, and a second position in which they substantially face the central hub.
Preferably, said passenger can swing their legs, at least partially over a side of said seat when taking up said second position.
Preferably, when in said second position, the feet of the passenger are located substantially beneath said hub.
Preferably, when in said first position, the feet of the passenger can be stretched out and be located substantially behind another seat adjacent said hub.
Preferably, for each seat, the central hub includes a recess to provide leg space to allow a passenger to rotate in their seat to assume a position tending to face or facing the central hub.
Preferably, each passenger in the seating arrangement can assume a position tending to face or facing the central hub.
Preferably, the hub includes a table top set at a height relative the adjacent seats to allow adjacent passengers to utilise this table top for activities requiring the support of objects.
Preferably, said hub includes a table top set at a height relative the adjacent seats to allow adjacent passengers to utilise said table top for activities requiring the support of objects and wherein,
each passenger in the seating arrangement can assume a position tending to face or facing the table top.
Preferably, the seating arrangement is positioned inboard of a passenger vehicle, and there is an aisle either side of the arrangement.
Preferably, a passenger in each seat of the arrangement has direct access to an aisle.
Preferably, said seating arrangement is repeated within the vehicle, and wherein the layout of an adjacent seating arrangement is mirrored with respect to the seating arrangement it is adjacent to.
Preferably, said seating arrangement is repeated within the vehicle, and wherein the layout of an adjacent seating arrangement is translated with respect to the seating arrangement it is adjacent to.
Preferably, said arrangement has a long axis intended to be substantially parallel with the main axis of the vehicle in which the arrangement is to be installed; and wherein

two of the seats in said arrangement are positioned to face at an angle from said long axis; and

two of the seats are positioned to face at a second angle from a short axis that is perpendicular to said long axis.

Preferably, the first two said seats are opposite each other across said hub.
Preferably, said first angle and said second angle is less than approximately 10 degrees.
Preferably, said angle and said second angle are approximately 5 degrees.
Preferably, said angle and said second angle are the same and each pair of said two seats is offset by the same angle.
Preferably, the vehicle is an aircraft.
Preferably, at least one multimedia monitor is suitably positioned to be viewable by a person in each seat of the seating arrangement.
Preferably, a privacy screen can be deployed to substantially block a passengers eye-line to the centre of the hub.
Preferably, a privacy screen can be deployed to reduce the ability of passengers sitting at the hub from viewing at least one other passenger at the hub.
Preferably, a privacy screen is able to be presented at an edge of the hub.
Preferably, at least one privacy screen is retained by the hub to be movable from a stored condition to a deployed condition where is presented in a substantially vertical condition to be presented in the field of view of at least one passenger at the hub in a location preventing them from seeing at least one other passenger at the hub.
Preferably, at least one privacy screen is retained by a seat at the hub, to be movable from a stored condition to a deployed condition where is presented in a substantially vertical condition to be presented in the field of view of at least one passenger at the hub in a location preventing them from seeing at least one other passenger at the hub.
Preferably, the rear of each seat is substantially surrounded by a rigid shell.
Preferably, said screen is retained by said rigid shell around said seat.
Preferably, at least one seat of the arrangement is reclinable.
Preferably, the seat pan of the seat slides forward to allow or when the seat back to recline.
Preferably, the seat reclines substantially within the confines of said shell.
Preferably, each for each seat there is a corresponding tray table.
Preferably, each tray table is engaged to the central hub:
Preferably, each tray table is movably mounted to the said central hub to move between a stored condition and a deployed condition.
Preferably, the tray table can move between said stored condition in which it is retracted substantially inside the central hub (eg parallel to and below the table top of the hub) and the deployed condition in which it is substantially extended from the central hub to provide a table surface for the passenger in the seat.
Preferably, a foot support is provided in front of at least one seat of the seating arrangement.
Preferably, the foot support is mounted to an adjacent seat of the arrangement.
Preferably, the central hub is mounted to the vehicle floor independently of the seats.
Preferably, the seats are mounted to the vehicle floor independently of one another.
Preferably, the central hub and seats are mounted to the vehicle floor together as a unit (eg on a plinth).
In a further aspect the invention comprises a vehicle comprising or including a seating arrangement as claimed in any one of the preceding claims.
Preferably, said seating arrangement is positioned inboard of a passenger vehicle so that there is an aisle either side of the arrangement.
Preferably, a passenger in each seat of the arrangement has direct access to the aisle.
Preferably, at least two said seating arrangements are provided, one where the right hand side of each seat is adjacent to its central hub so that the seat face in a clockwise direction about the central hub and another where the left hand side of each seat is adjacent to its central hub so that the seats face in an anti-clockwise direction about the central hub wherein one seat of the first mentioned arrangement is adjacent to and facing in the same direction as a seat of the second mentioned arrangement.
Preferably, at least two said seating arrangements are provided, one where the right hand side of each seat is adjacent to its central hub so that the seat face in a clockwise direction about the central hub and another where the left hand side of each seat is adjacent to its central hub so that the seats face in an anti clockwise direction, the two arrangements being mounted within the vehicle as a mirror image of each other.
Preferably, the two arrangements are mirror imaged in an immediate juxtaposition to one another.
Preferably, a plurality of seating arrangements are provided that are repeated throughout the vehicle, wherein the layout of an adjacent seating arrangement is mirrored with respect to the seating arrangement on one side adjacent thereto.
Preferably, a plurality of seating arrangements are provided that are repeated throughout the vehicle, wherein the layout of an adjacent seating arrangement is translated with respect to the seating arrangement on one side adjacent thereto.
Preferably, at least three adjacent said seating arrangements are provided in a row, wherein for any given group of three arrangements
(i) the intermediate arrangement has its seats positioned in an orientation selected from one where
   (a) the right hand side of each seat is adjacent to its central hub so that the seat face in a clockwise direction or
   (b) the left hand side of each seat is adjacent to its central hub so that the seat face in an anticlockwise direction

and
(ii) each arrangement adjacent the intermediate arrangement has its seats positioned in an orientation selected from one opposite to that of (i) where
   (a) the left hand side of each seat is adjacent to its central hub so that the seat face in an anticlockwise direction or
   (b) the right hand side of each seat is adjacent to its central hub so that the seat face in a clockwise direction.
      Preferably, two seats, on opposite sides of the hub of the intermediate arrangement, are adjacent to and facing in the same direction as a seat of the each arrangement adjacent.
      Preferably, a vertical mirror image plane can established between the intermediate arrangement and each of the arrangements adjacent.
      Preferably, the vehicle is a passenger aircraft.
      In a further aspect the invention comprises a seating arrangement as herein before described and with reference to any one or more of FIGS. 1 to 7.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

The entire disclosures of all applications, patents and publications, cited above and below, if any, are hereby incorporated by reference.

### BRIEF DESCRIPTION OF THE DRAWINGS

The invention will now be described by way of example only and with reference to the drawings in which:

FIG. 1 is a plan view of a seating arrangement of the present invention,

FIG. 2 is a perspective view of the seating arrangement of FIG. 1,

FIG. 3 is a plan view of two adjacent seating arrangements,

FIG. 4 is a perspective view of the two adjacent seating arrangements of FIG. 3,

FIG. 5 is a side view of the seating arrangements of FIG. 4,

FIG. 6 is a perspective view of a vehicle with multiple seating arrangements.

FIG. 7 is a plan view of a seating arrangement according to further aspect of the invention,

FIG. 8 is a perspective view of the seating arrangement of FIG. 7,

FIG. 9 is a side view of the seating arrangement of FIG. 7.

### DETAILED DESCRIPTION OF THE INVENTION

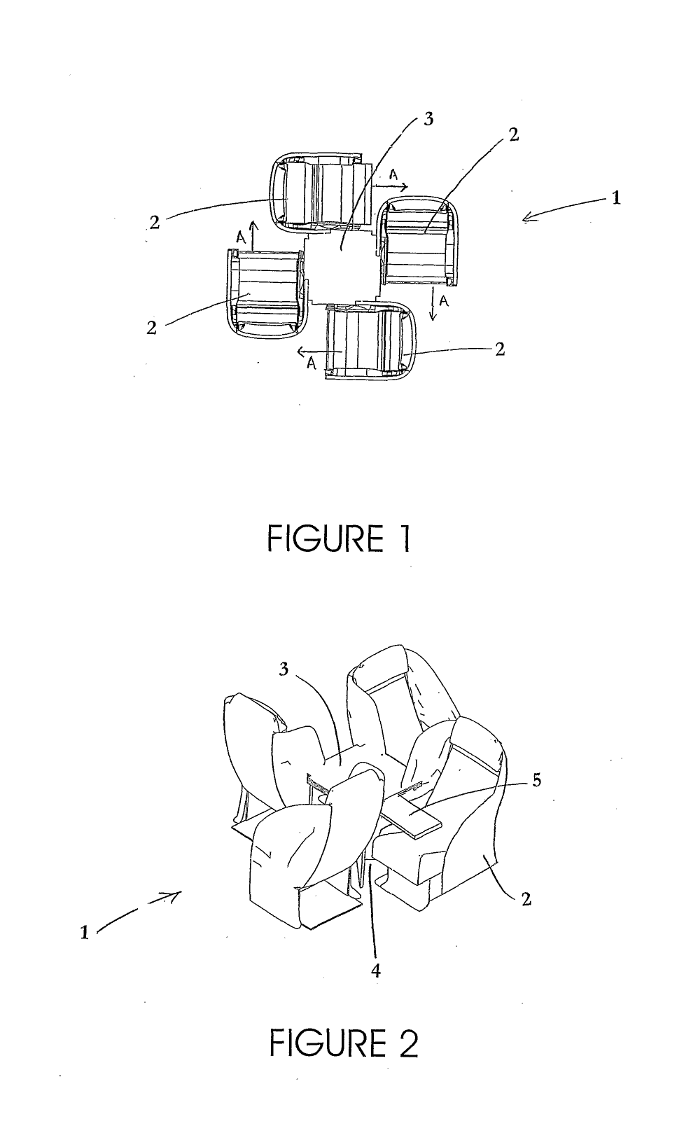

With reference to FIG. 1 there is shown a plan view of a seating arrangement 1 of the present invention. The arrangement 1 may be suitable for a passenger vehicle such as an aircraft, train or bus. Preferably the seating arrangement 1 is for an aircraft.

The seats 2 are arranged around a central hub 3. FIG. 1 shows each seat 2 faces in the direction indicated by the arrow CAD. Therefore, the seats face in a direction substantially parallel with the side of the central hub 3 to which they are adjacent. In the arrangement shown in FIG. 1, the right hand side of each seat 2 is adjacent to a side of the hub 3, to create a generally clockwise arrangement of seats 2 about the central table. Alternatively, the left hand side of each seat 2 may be adjacent to a side of the table 3, to create a generally anti-clockwise arrangement of seats 2 about the central hub.

The central hub 3 preferably includes a substantially horizontal planar surface that can be used as a table for the passengers located in the seats 2 around it. The central hub 3 may provide a means to engage with the other passengers, and/or a surface on which to do work, play games, or support food or drinks.

The seats 2 may be offset backwardly from the side of the central hub 3 to which they are adjacent. In the preferred embodiment the front edge of the seats (when in their upright position) may line up with a point part way along the length of the side of the central hub 3. For example, the front edge of each seat 2 may line up approximately halfway or ⅔ along the length of the table side. It should be appreciated that the seats may be positioned in any way relative to the side of the central hub. When positioned as described above, each passenger in each seat of the seating arrangement 1 has direct access to the aisle without disturbing other passengers in the seating arrangement 1.

FIG. 2 shows in perspective view the seating arrangement of FIG. 1. A recess 4 may be located on each side of the central hub 3 under the table-top surface. The recess 4 allows for a passenger located in each seat 2 to rotate to substantially face the central hub 3 and provides leg room for the passenger. The recess for under the table top of the hub allows passengers to swing their legs under the table top towards the hub thereby reducing the amount of twisting in the passengers body when seated in that position.

It may be easier for passengers to engage one another when facing toward the central hub 3. Therefore, this arrangement allows a passenger to move between a first position in which they face substantially in the direction ‘A’ of FIG. 1, and a second position in which they substantially face the central hub so that they may engage the other passengers of the arrangement more directly. This arrangement, may allow for flexibility, depending on whether a passenger wishes to converse with others sitting around a common hub 3, or have privacy. It will be appreciated that each passenger seated in a seat 2 around hub 3 may independently choose to turn towards the central hub or not. There are therefore several combinations of options for passengers who choose to engage with others seated around the same hub or not.

A tray table 5 may be provided from each side of the central hub 3. The tray table 5 may extend from the central hub 3 so that a passenger located in a seat 2 can use it for eating a meal or any other activity while facing substantially in direction ‘A’. Preferably the tray table retracts to be located substantially within the central hub 3 when not in use. Alternatively the tray table 5 may be adapted to extend and retract in any other suitable manner. Each seat 2 of the arrangement may have a corresponding tray table 5.

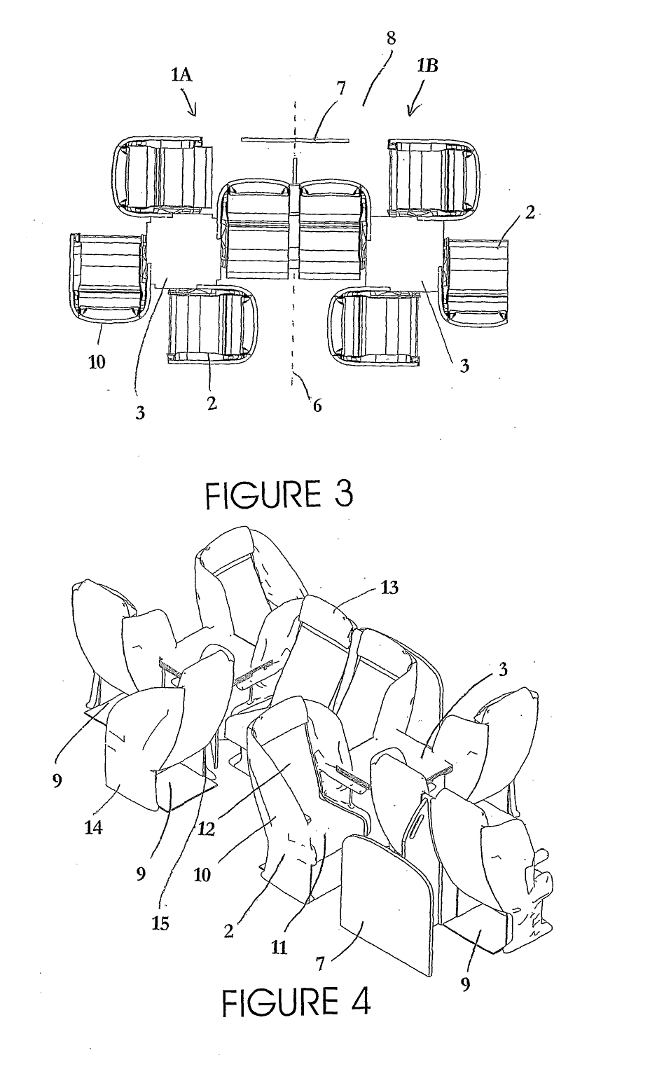

Multiple seating arrangements 1 may be located adjacent to one another in a passenger vehicle. FIG. 3 shows how two adjacent seating arrangements 1 may be positioned relative to each other. As shown, the seats 2 of the seating arrangement 1A face in a clockwise arrangement around the central hub 3. In contrast, the seats 2 of the seating arrangement 1B face in an anti-clockwise direction around the central hub 3. In this way, the arrangement 1B is a mirror of arrangement 1A. The arrangements 1A about mirror line 6. The sides of the seats proximate mirror line 6 are preferably located close to each other. When arranged close or even immediately adjacent to each other, an opportunity is provided for a pair of passengers to sit side by side without any substantial obstructions between them. A mobile arm rest may be provided between these two adjacent seats for this purpose. Further, a mobile screen may also be provided so that passengers in these two seats can configured the screen and/or arm rest to separate them or obstruct the eye line or access between passengers.

Alternatively, two adjacent seating arrangements 1 may both have their seats 2 facing in a clockwise direction or an anticlockwise direction about the central hub 3. In this case, the adjacent seating arrangements are not mirrored but are translated. The two adjacent seats from neighbouring seating arrangements face toward each other such that the passengers are substantially face to face. This arrangement may improve those passengers ability to engage with each other. It is envisaged that a privacy screen may be provided to be selectively deployed or retracted to shield those passengers sight-lines from each other. For example, a retractable privacy screen may be provided from each passengers perspective arm rest or from a surrounding seat shell for this purpose.

A partition 7 may be provided between two adjacent seating arrangements 1A and 1B. The partition 7 may encourage the passenger's legs to remain within the seating arrangement 1 and restrict their legs from entering the aisle area 8. This partition may also help items stowed near the passengers feet from entering the isle.

There may be a recess 9 under each seat. The recess 9 may be suitable for placing luggage or any other objects therein. In particular, the recess under each seat may be at least partially utilised for another passengers feet. For example, the passenger sitting in the seat 13 (shown in FIG. 4) may utilise some of the space in recess 9 under seat 14 for their feet. It may be preferred that the support 15 (one side of seat 14) is shaped to optimise access for the feet of the passenger sitting in seat 13. It is preferable that the amount of twist in a passengers body while seated is minimised in order to improve comfort level.

The seats 2 may have a rigid shell 10 that somewhat encompasses a passenger as generally shown. The rigid shell 10 may be used to promote individual space. The rigid shell 10 may be manufactured from any suitable materials such as plastics or composite materials. With reference to FIG. 3, shell 10 may be configured asymmetrically to provide more shielding of the passenger seat from the aisle compared to the hub 3. It is envisaged that the shell structure may also be used to provide comfortable lateral head rest support for passengers when sleeping. The encompassing nature of the shell lends itself to this purpose.

The seats 2 may be reclinable within their rigid shells 10. The seat may recline in any suitable way. Preferably the seat pan 11 can slide in a forwards direction, to allow the seat back 12 to move into a more reclined orientation. Because the seat is located within the rigid shell 10, a reclining seat 2 will not impede on the space behind.

A foot support may be provided at some position in front of each seat. The foot support may be fixed in place or may fold out from the back of an adjacent seat. The foot rest may fold out such that it is located at least partially in recess 9.

It is preferred that the seating arrangements 1 are located centrally in a passenger vehicle to allow each passenger aisle access. It is envisaged that a vehicle may have many seating arrangements 1 located side by side. As shown in FIG. 6, the seating arrangements 1 are located inboard of the vehicle so that there is an aisle 8 either side of the seating arrangements 1. Each seating arrangement 1 is also mirrored with respect to the adjacent arrangement 1. In this configuration, each passenger has direct aisle access from their seat 2.

The central hub 3 may be mounted to the floor of the vehicle independently of the seats. Alternatively, the central hub 3 and seats 4 may be mounted to the floor of the vehicle as a unit such as on a plinth.

It is envisaged that the seating arrangements 1 may have additional features such as in flight entertainment (IFE). This may include multimedia monitors positioned to be viewable by each occupant of a seat 2.

Privacy screens may also be deployed to block a seat off from the central hub 3. The privacy screens may be configured in any suitable way, for example the privacy screens may extend from an adjacent seat in the central hub 3, or may be extended upwards from the table top. Alternatively, privacy screens may extend and retract from shell 10 around each seat 2. The seating arrangement of the present invention allows considerable flexibility and options for passengers travelling singly, in pairs, or groups. In particular, passengers travelling in groups of up to four may have improved ability to interact around a common hub or table top 3. It is anticipated that a group of passengers can book seats together in the seating arrangement of the present invention.

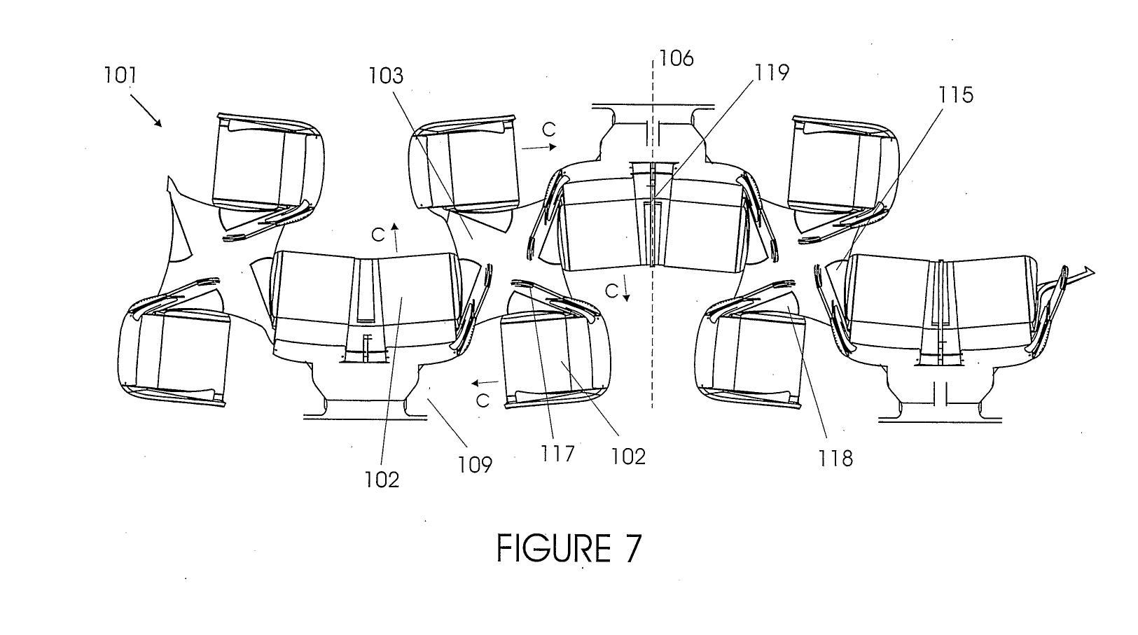

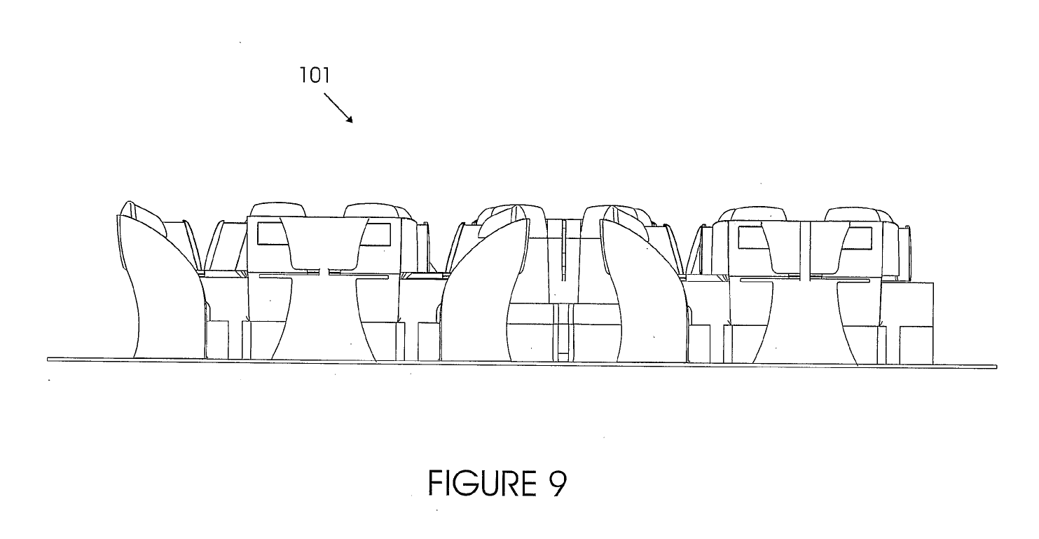

With particular reference to FIGS. 7 to 9 an alternative embodiment of the present seating arrangement will be described in more detail. For convenience like numerals will be used to indicate similarity between features of alternative embodiments.

With reference to FIG. 7 there is shown a plan view of a seating arrangement 101. The arrangement 101 has seats 102 arranged about a central hub 103. Each seat 102 faces in a direction indicated by arrow ‘C’. Therefore, the seats face in a direction which is off set with respect to arrow ‘A’ as shown in FIG. 1 and described in relation to the first embodiment of the present invention.

As illustrated in FIG. 7 two of the seats located around common hub 3 are off set from an axis substantially parallel with the axis of the vehicle. The remaining two seats around the common hub 3 are off set from an axis perpendicular to the vehicle axis. The off set may provide improved ingress and egress from the seats 102 into the aisle. In particular, the off set may improve a passengers comfort by improving access to recess 109 for the passengers feet. The offset angle allows a passenger to stretch out their feet without needing to twist their body position as much.

It is preferred that the off set angle is sufficient to allow improved foot space (especially when the passenger in the seat is reclined). It has been found that an off set angle of up to approximately 10° provides improved comfort without requiring too much space for the overall seating arrangement in the vehicle. In a most preferred embodiment the off set angle is approximately 5°.

Central hub 103 has four sides and may also be off set such that the seats face in a direction substantially parallel with the side of the central hub 103 to which they are adjacent. It will be appreciated that in this context, the ‘side’ of the central hub has a meaning broad enough to encompass designs such as that shown in FIG. 7, where the sides of the hubs are ergonomically sculpted and are not straight lines.

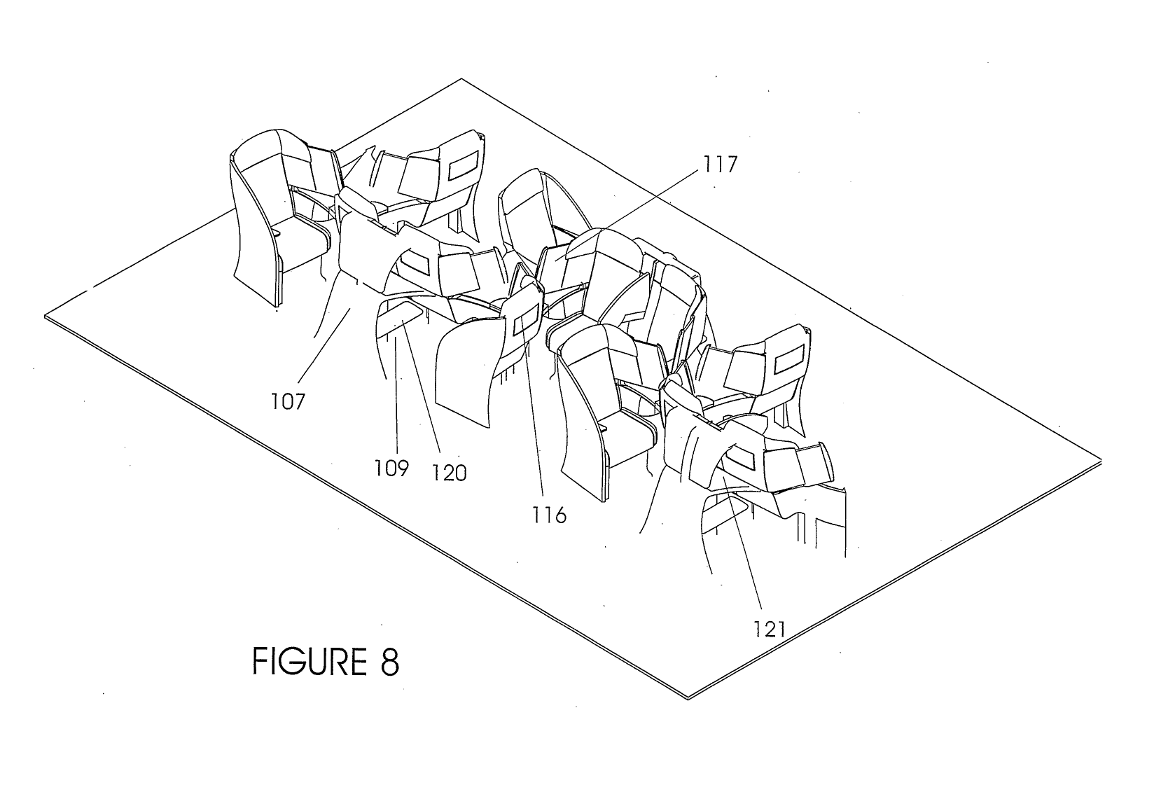

With reference to FIG. 8, in flight entertainment screens are shown in the back of each seat and are moveable to face a passenger sitting in the seat behind. Alternative privacy screens 117 are shown deployed for some seats illustrated in FIG. 7. Central hub 103 may also be provided with an extendable tray 105 or console 118 or both. The extendable tray is configured to provide an additional surface for the passengers use particularly when facing in direction ‘C’. The console 118 may be provided to control or interact with the in flight entertainment system.

In a similar matter to the first embodiment, the seating arrangement 101 may be mirrored or translated to provide additional adjacent seating. When mirrored, about mirror line 106 “as shown in FIG. 7”, the two adjacent seats may include a moveable privacy screen and/or arm rest.

With reference to FIG. 8, the recess 109 is shown having foot rest 120 deployed. The off set angle may provide additional storage space as well as feet space in recess 109. The offset angle may be the same for seats opposite each other around the hub or all seats may have the same offset.

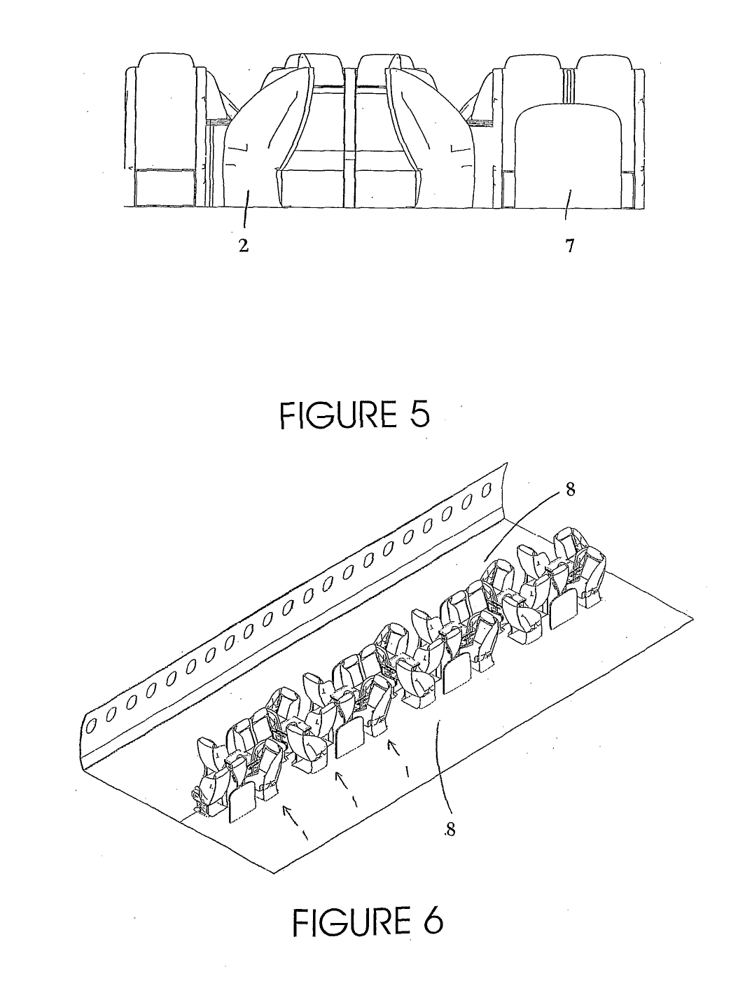

It will be appreciated that the embodiment of the invention shown in FIGS. 7 to 9 enjoys all of the advantages described with reference to the embodiments shown in FIGS. 1 to 6.

Optionally, additional table and/or storage space may be provided above foot space 109.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A vehicle seating arrangement comprising or including:
a central hub having four sides,
a seat located adjacent to, and facing in a direction substantially parallel with, each side of the central hub.

2. A vehicle seating arrangement as claimed in claim 1, wherein each seat is located relative said side of the hub to which it is adjacent, so that the front edge of each seat, at least when the seat is in the fully upright position, does not project beyond said side of the hub.

3. A vehicle seating arrangement as claimed in claim 1, wherein each seat is located relative said side of the hub to which it is adjacent, so that the front edge of each seat, at least when the seat is in the fully upright position, is located intermediate of the distal ends of said side.

4. A vehicle seating arrangement as claimed in claim 1, wherein each seat is set relative said side of the hub to which it is adjacent, so that the back each seat, at least when the seat is in the fully upright position, extends beyond one of the distal ends of said side.

5. A vehicle seating arrangement as claimed in claim 1, wherein the central hub is substantially square in plan shape.

6. A vehicle seating arrangement as claimed in claim 1, wherein the right hand side of each seat is adjacent to the central hub so that the seats face in a clockwise direction about the central hub.

7. A vehicle seating arrangement as claimed in claim 1, wherein the left hand side of each seat is adjacent to the central hub so that the seats face in an anti-clockwise direction about the central hub.

8. A vehicle seating arrangement as claimed in claim 1, wherein the seating arrangement enables passengers to assume a first position in which they face in a direction substantially parallel to the direction that the seat faces, and a second position in which they substantially face the central hub.

9. A vehicle seating arrangement as claimed in claim 8, wherein said passenger can swing their legs, at least partially over a side of said seat when taking up said second position.

10. A vehicle seating arrangement as claimed in claim 8, wherein when in said second position, the feet of the passenger are located substantially beneath said hub.

11. A vehicle seating arrangement as claimed in claim 8, wherein when in said first position, the feet of the passenger can be stretched out and be located substantially behind another seat adjacent said hub.

12. A vehicle seating arrangement as claimed in claim 1, wherein for each seat, the central hub includes a recess to provide leg space to allow a passenger to rotate in their seat to assume a position tending to face or facing the central hub.

13. A vehicle seating arrangement as claimed in claim 1, wherein each passenger in the seating arrangement can assume a position tending to face or facing the central hub.

14. A vehicle seating arrangement as claimed in claim 1, wherein the hub includes a table top set at a height relative the adjacent seats to allow adjacent passengers to utilise this table top for activities requiring the support of objects.

15. A vehicle seating arrangement as claimed in claim 1, wherein said hub includes a table top set at a height relative the adjacent seats to allow adjacent passengers to utilise said table top for activities requiring the support of objects and wherein,
each passenger in the seating arrangement can assume a position tending to face or facing the table top.

16. A vehicle seating arrangement as claimed in claim 1, wherein the seating arrangement is positioned inboard of a passenger vehicle, and there is an aisle either side of the arrangement.

17. A vehicle seating arrangement as claimed in claim 16, wherein a passenger in each seat of the arrangement has direct access to an aisle.

18. A vehicle seating arrangement as claimed in claim 1, wherein said seating arrangement is repeated within the vehicle, and wherein the layout of an adjacent seating arrangement is mirrored with respect to the seating arrangement it is adjacent to.

19. A vehicle seating arrangement as claimed in claim 1, wherein said seating arrangement is repeated within the vehicle, and wherein the layout of an adjacent seating arrangement is translated with respect to the seating arrangement it is adjacent to.

20. A vehicle seating arrangement as claimed in claim 1, wherein said arrangement has a long axis intended to be substantially parallel with the main axis of the vehicle in which the arrangement is to be installed; and wherein
two of the seats in said arrangement are positioned to face at an angle from said long axis; and
two of the seats are positioned to face at a second angle from a short axis that is perpendicular to said long axis.

21. A vehicle seating arrangement as claimed in claim 20, wherein the first two said seats are opposite each other across said hub.

22. A vehicle seating arrangement as claimed in claim 20, wherein said first angle and said second angle is less than approximately 10 degrees.

23. A vehicle seating arrangement as claimed in claim 20, wherein said angle and said second angle are approximately 5 degrees.

24. A vehicle seating arrangement as claimed in claim 20, wherein said angle and said second angle are the same and each pair of said two seats is offset by the same angle.

25. A vehicle seating arrangement as claimed in claim 1, wherein the vehicle is an aircraft.

26. A vehicle seating arrangement as claimed in claim 1 wherein at least one multimedia monitor is suitably positioned to be viewable by a person in each seat of the seating arrangement.

27. A vehicle seating arrangement as claimed in claim 1, wherein a privacy screen can be deployed to substantially block a passengers eye-line to the centre of the hub.

28. A vehicle seating arrangement as claimed in claim 1, wherein a privacy screen can be deployed to reduce the ability of passengers sitting at the hub from viewing at least one other passenger at the hub.

29. A vehicle seating arrangement as claimed in claim 1, wherein a privacy screen is able to be presented at an edge of the hub.

30. A vehicle seating arrangement as claimed in claim 1, wherein at least one privacy screen is retained by the hub to be movable from a stored condition to a deployed condition where is presented in a substantially vertical condition to be presented in the field of view of at least one passenger at the hub in a location preventing them from seeing at least one other passenger at the hub.

31. A vehicle seating arrangement as claimed in claim 1, wherein at least one privacy screen is retained by a seat at the hub, to be movable from a stored condition to a deployed condition where is presented in a substantially vertical condition to be presented in the field of view of at least one passenger at the hub in a location preventing them from seeing at least one other passenger at the hub.

32. A vehicle seating arrangement as claimed in claim 1, wherein the rear of each seat is substantially surrounded by a rigid shell.

33. A vehicle seating arrangement as claimed in claim 32, wherein said screen is retained by said rigid shell around said seat.

34. A vehicle seating arrangement as claimed in claim 1, wherein at least one seat of the arrangement is reclinable.

35. A vehicle seating arrangement as claimed in claim 1, wherein the seat pan of the seat slides forward to allow or when the seat back to recline.

36. A vehicle seating arrangement as claimed in claim 32, wherein the seat reclines substantially within the confines of said shell.

37. A vehicle seating arrangement as claimed in claim 1, wherein each for each seat there is a corresponding tray table.

38. A vehicle seating arrangement as claimed in claim 37, wherein each tray table is engaged to the central hub.

39. A vehicle seating arrangement as claimed in claim 37, wherein each tray table is movably mounted to the said central hub to move between a stored condition and a deployed condition.

40. A vehicle seating arrangement as claimed in claim 37, wherein the tray table can move between said stored condition in which it is retracted substantially inside the central hub and the deployed condition in which it is substantially extended from the central hub to provide a table surface for the passenger in the seat.

41. A vehicle seating arrangement as claimed in claim 1, wherein a foot support is provided in front of at least one seat of the seating arrangement.

42. A vehicle seating arrangement as claimed in claim 41, wherein the foot support is mounted to an adjacent seat of the arrangement.

43. A vehicle seating arrangement as claimed in claim 1, wherein the central hub is mounted to the vehicle floor independently of the seats.

44. A vehicle seating arrangement as claimed in claim 1, wherein the seats are mounted to the vehicle floor independently of one another.

45. A vehicle seating arrangement as claimed in claim 1, wherein the central hub and seats are mounted to the vehicle floor together as a unit (eg on a plinth).

46. A vehicle comprising or including a seating arrangement as claimed in claim 1.

47. A vehicle as claimed in claim 46, wherein said seating arrangement is positioned inboard of a passenger vehicle so that there is an aisle either side of the arrangement.

48. A vehicle as claimed in claim 46, wherein a passenger in each seat of the arrangement has direct access to the aisle.

49. A vehicle as claimed in claim 46, wherein at least two said seating arrangements are provided, one where the right hand side of each seat is adjacent to its central hub so that the seat face in a clockwise direction about the central hub and another where the left hand side of each seat is adjacent to its central hub so that the seats face in an anti-clockwise direction about the central hub wherein one seat of the first mentioned arrangement is adjacent to and facing in the same direction as a seat of the second mentioned arrangement.

50. A vehicle as claimed in claim 46, wherein at least two said seating arrangements are provided, one where the right hand side of each seat is adjacent to its central hub so that the seat face in a clockwise direction about the central hub and another where the left hand side of each seat is adjacent to its central hub so that the seats face in an anti clockwise direction, the two arrangements being mounted within the vehicle as a mirror image of each other.

51. A vehicle as claimed in claim 50, wherein the two arrangements are mirror imaged in an immediate juxtaposition to one another.

52. A vehicle as claimed in claim 46, wherein a plurality of seating arrangements are provided that are repeated throughout the vehicle, wherein the layout of an adjacent seating arrangement is mirrored with respect to the seating arrangement on one side adjacent thereto.

53. A vehicle as claimed in claim 46, wherein a plurality of seating arrangements are provided that are repeated throughout the vehicle, wherein the layout of an adjacent seating arrangement is translated with respect to the seating arrangement on one side adjacent thereto.

54. A vehicle as claimed in claim 46, wherein at least three adjacent said seating arrangements are provided in a row, wherein for any given group of three arrangements
(i) the intermediate arrangement has its seats positioned in an orientation selected from one where
(a) the right hand side of each seat is adjacent to its central hub so that the seat face in a clockwise direction or
(b) the left hand side of each seat is adjacent to its central hub so that the seat face in an anticlockwise direction
and
(ii) each arrangement adjacent the intermediate arrangement has its seats positioned in an orientation selected from one opposite to that of (i) where
(a) the left hand side of each seat is adjacent to its central hub so that the seat face in an anticlockwise direction or
(b) the right hand side of each seat is adjacent to its central hub so that the seat face in a clockwise direction.

55. A vehicle as claimed in claim 46, wherein two seats, on opposite sides of the hub of the intermediate arrangement, are adjacent to and facing in the same direction as a seat of the each arrangement adjacent.

56. A vehicle as claimed in claim 46, wherein a vertical mirror image plane can established between the intermediate arrangement and each of the arrangements adjacent.

57. A vehicle as claimed in claim 46, wherein the vehicle is a passenger aircraft.

58.-59. (canceled)
